(19) United States
(12) Patent Application Publication
(10) Pub. No.: US 2012/0114965 A1
(43) Pub. Date: May 10, 2012

(54) Laminate for HDD Suspension and Method for Manufacturing the Same

(75) Inventors: Kengo Takada, Chiba (JP); Naoya Kobayashi, Chiba (JP); Kazunori Oomizo, Chiba (JP); Mari Sakurai, Chiba (JP)

(73) Assignee: Nippon Steel Chemical Co., Ltd., Tokyo (JP)

(21) Appl. No.: 11/887,415

(22) PCT Filed: Mar. 24, 2006
(86) PCT No.: PCT/JP2006/305922

§ 371 Date: Aug. 25, 2009

(30) Foreign Application Priority Data
Mar. 31, 2005 (JP) 2005-104158

(51) Int. Cl. B32B 15/088; B05D 5/12; B32B 15/18

(52) U.S. Cl. 428/612; 428/621; 427/58

(57) ABSTRACT

Provided are a laminate for HDD suspension capable of avoiding data loss and crosstalk caused by higher frequency and coping with reduction in size and increase in capacity of HDD and a method for manufacturing the same. The laminate for HDD suspension comprises a 10-50 μm-thick stainless steel layer, a 0.1-10 μm-thick conductor layer (a) of a metal showing an electrical conductivity of 10-100% IACS, a 5-20 μm-thick insulating layer of a polyimide resin showing a linear expansion coefficient of 1×10⁻⁵-3×10⁻⁵/° C., and a 5-50 μm-thick conductor layer (b). The manufacturing method comprises applying a solution of a polyimide precursor in one layer or more to a conductor layer (a) of a laminate consisting of a stainless steel layer and a conductor layer (a), drying the polyimide precursor layer and then heating at 250° C. or above thereby forming a 5-20 μm-thick insulating layer of polyimide resin with a linear expansion coefficient of 1×10⁻⁵-3×10⁻⁵/° C., placing a 5-50 μm-thick conductor layer (b) on the insulating layer, and pressing under heat and pressure.

### FIELD OF TECHNOLOGY

This invention relates to a substrate material for HDD suspension and to a method for manufacturing the same.

### BACKGROUND TECHNOLOGY

The output of hard disk drives (hereinafter referred to as HDDs) has increased in recent years everywhere in the related industry due to an increase in demand for personal computers and also due to development of a variety of new applications to electrical appliances and car navigation system. HDDs are expected to move toward higher data storage capacity and smaller size and suspensions that constitute a flexure blank for magnetic reading in HDDs (hereinafter referred to as HDD suspensions) are also moving toward smaller size and use of a larger number of narrower lines in wiring. As higher data storage capacity is attained, the conventional suspensions of the wire type have mostly been replaced by suspensions of the integrally-wired type that shows stable flying height and positional accuracy relative to the memory medium or the disk. A suspension of this type is fabricated by the TSA (trace suspension assembly) process by etching a laminate consisting of a stainless steel foil, a polyimide resin, and a copper foil to a prescribed shape.

A suspension of the TSA type allows easy formation of a flying lead by lamination of a high-strength copper alloy foil and it enjoys a wide use on account of a high degree of freedom in shape fabrication, relatively low cost, and high dimensional accuracy. In WO98/08216 is disclosed a laminate for HDD suspension which is obtained by forming a layer of polyimide resin and a conductor layer one upon another on a stainless steel substrate.

However, movement toward the use of higher frequency to deal with a higher density of data resulting from an increase in the data storage capacity is likely to cause a problematical increase in high frequency signal loss. Furthermore, reduced distance between lines in finer wiring necessitated by reduction in size possibly causes a response error, called crosstalk, between these fine lines. In JP9-283930 A is disclosed a multilayer printed wiring board devised to avoid an erroneous operation of adjacent patters by crosstalk noise in a microstrip structure and are further disclosed the structure and manufacturing method of this wiring board.

Patent document 1: WO98/08216 pamphlet

Patent document 2: JP9-283930 A

### DISCLOSURE OF THE INVENTION

### Problems to be Solved by the Invention

An object of this invention is to provide a conductor layer as an earthing layer on a stainless steel layer that functions as a spring in the conventional substrate materials for suspensions thereby avoiding data loss and crosstalk in the use of higher frequency and to provide a laminate for suspension capable of coping with reduction in size and increase in data storage capacity of HDDs and a method for manufacturing the said laminate.

### Means to Solve the Problems

The inventors of this invention have conducted intensive studies to solve the aforementioned problems and completed this invention by manufacturing a laminate comprising a stainless steel layer one side of which is electroplated with a conductor.

Accordingly, this invention relates to a laminate for HDD suspension comprising a stainless steel layer, a conductor layer (a), an insulating layer, and a conductor layer (b) wherein the conductor layer (a) consists of a metal with an electrical conductivity in the range of 10-100% IACS, the stainless steel layer is 10-50 μm in thickness, the conductor layer (a) is 0.1-10 μm in thickness, the insulating layer is 5-20 μm in thickness, the conductor layer (b) is 5-50 μm in thickness, and the insulating layer consists of a polyimide resin with a linear expansion coefficient of 1×10⁻⁵-3×10⁻⁵/° C.

Further, this invention relates to a method for manufacturing a laminate for HDD suspension which comprises applying a solution of a polyimide precursor or polyimide resin in one layer or more to a conductor layer. (a) of a laminate consisting of a stainless steel layer with a thickness of 10-50 μm and a conductor layer (a) with a thickness of 0.1-10 μm, drying and then heating at 250° C. or above thereby forming an insulating layer of polyimide resin with a linear expansion coefficient of 1×10⁻⁵-3×10⁻⁵/° C. in a thickness of 5-20 μm, then placing a conductor layer (b) with a thickness of 5-50 μm on the insulating layer, and pressing under heat and pressure.

Still further, this invention relates to a method for manufacturing a laminate for HDD suspension which comprises applying a solution of a polyimide precursor or polyimide resin in one layer or more to a conductor layer (b) with a thickness of 5-50 μm, drying and then heating at 250° C. or above thereby forming an insulating layer of polyimide resin with a linear expansion coefficient of 1 x 10⁻⁵-3×10⁻⁵/° C. in a thickness of 5-20 μm, then placing a laminate consisting of a stainless steel layer with a thickness of 10-50 μm and a conductor layer (a) with a thickness of 0.1-30 μm on the insulating layer with the conductor layer (a) faced to the insulating layer, and pressing under heat and pressure.

### Effects of the Invention

In the laminate for an HDD suspension of this invention, provision of the conductor layer (a) as an earthing layer on the stainless steel layer functioning as a spring helps an HDD suspension comprising the laminate to avoid data loss crosstalk caused by the use of higher frequency and cope with reduction in size and increase in data storage capacity of HDDs. According to this invention, it is further possible to manufacture a laminate for an HDD suspension which develops excellent adhesion between the insulating layer and the conductor layer (a) or (b) and exhibits high dimensional accuracy.

The conductor layer (a) in this invention is formed from a metal having an electrical conductivity of 10% IACS or more and, in particular, it is desirable to select a conductive metal from Cu and Cu alloys. In this case, the electrical conductivity must be in the range of 10-100% IACS. The metal whose electrical conductivity is outside the lower limit of this range is unable to suppress crosstalk and causes an error in operation. On the contrary, a metal whose electrical conductivity is above 100% IACS is not necessarily desirable as the material cost rises. The electrical conductivity (% IACS) here represents the value when the specimen was tested by the four-point probe method against the International Annealed Copper Standard with the standard taken as 100% IACS which corresponds to 1.7241×10⁻⁸ Ω·m.

Moreover, it is desirable to provide a layer consisting of Cr, Mo, Ni, Si and a mixture thereof between the conductor layer (a) and the stainless steel layer to secure a sufficient peel strength between the two layers.

The conductor layer (a) is formed on the stainless steel layer easily by a method such as plating. Prior to the plating operation, it is preferable to provide the aforementioned layer consisting of Cr, Mo, Ni, Si and a mixture thereof on the stainless steel layer by a method such as electroplating and vacuum deposition as a surface treatment of the stainless steel layer. The conductor layer (a) is formed on such surface-treated stainless steel layer by electroplating or the like. Copper or a copper alloy exhibiting excellent electrical conductivity is used to form the conductor layer (a) in a thickness of 0.1-10 μm. When the conductor layer (a) has a thickness of less than 0.1 μm, the noise-reducing effect is produced with difficulty. On the other hand, when the conductor layer (a) has a thickness in excess of 10 μm, the layer becomes difficult to form in a uniform thickness and variation in product quality may occur. Furthermore, the surface roughness Ra of the surface in contact with the conductor layer (a) and the insulating layer is desirably controlled at 0.1-1.0 μm. A surface roughness of less than 0.1 μm lowers the adhesive strength to the insulating layer while a surface roughness of greater than 1.0 μm does not produce the noise-reducing effect uniformly. The aforementioned Ra denotes the arithmetic mean of the surface roughness (JIS B 0601-1994).

The stainless steel layer in this invention is not limited, but a stainless steel foil, concretely an SUS304 foil, is used preferably from the viewpoint of spring characteristics and dimensional stability. It is particularly preferable to use SUS304 that has been annealed at 300° C. or above. The thickness of the stainless steel layer is in the range of 10-50 μm, preferably in the range of 18-30 μm. A stainless steel layer with a thickness of less than 10 μm may not be endowed with sufficient spring characteristics to suppress the flying height of a slider. On the other hand, a stainless steel layer with a thickness in excess of 50 μm becomes too rigid and a slider to be mounted may fly low with difficulty.

The insulating layer in this invention is preferably made from a polyimide resin. The resin may be polyimide, polyamideimide, or polyetherimide or any resin which contains an imide linkage in its structure. The thickness of the insulating layer is 5-20 μm, preferably 7-18 μm. When the thickness is less than 5 μm, the reliability of electrical insulation drops and at the same time the dielectric characteristics deteriorate. On the other hand, when the thickness exceeds 20 μm, the patterning of the insulating layer becomes difficult to perform with high accuracy. The linear expansion coefficient of the insulating layer is 1×10⁻⁵-3×10⁻⁵/° C., preferably 1.5×10⁻⁵-2.5×10⁻⁵/° C. Regardless of whether the linear expansion coefficient is less than 1×10⁻⁵/° C. or more than 3×10⁻⁵/° C., warpage tends to occur easily when the stainless steel layer, the conductor layer (a), or the conductor layer (b) is removed from the laminate by etching.

According to this invention, the adhesive strength between the insulating layer and the conductor layer (a) and that between the insulating layer and the conductor layer (b) are preferably in the range of 0.5-10 kN/m. Hence, it is desirable that a layer of polyimide resin constituting the insulating layer has certain adhesive properties. Now, a layer of polyimide resin having a linear expansion coefficient in excess of 3×10⁻⁵/° C. generally tends to develop a relatively good adhesive strength against a conductor layer of metal; however, a layer of polyimide resin having a linear expansion coefficient of 1×10⁻⁵-3×10⁻⁵/° C. does not tend to show good adhesive strength against metals. Because of this, a preferable configuration of a layer of polyimide resin in this invention is a multilayer structure consisting of at least two layers, for example, a layer of polyimide resin of low thermal expansion with a linear expansion coefficient of 2.5×10⁻⁵/° C. or less and a layer of polyimide resin of high thermal expansion with a linear expansion coefficient of 3×10⁻⁵/° C. or more.

A more preferable configuration is a three-layer structure consisting of a layer of first polyimide resin of high thermal expansion with a linear expansion coefficient of 3×10⁻⁵/° C. or more, a layer of polyimide resin of low thermal expansion with a linear expansion coefficient of 2.5×10⁻⁵/° C. or less, and a layer of second polyimide resin of high thermal expansion with a linear expansion coefficient of 3×10⁻⁵/° C. or more. Here, the first and second polyimide resins of high thermal expansion may be identical with or different from each other. A multilayer structure constructed by combining a layer of polyimide resin of low thermal expansion and a layer of polyimide resin of high thermal expansion makes it possible to provide an insulating layer that satisfies the two conditions of low thermal expansion and high adhesiveness.

In the case where an insulating layer is formed from three layers or more of polyimide resins, it is preferable to control the ratio of the total thickness (ta) of the two outer polyimide layers to the total thickness (tb) of the inner polyimide layers or the ratio (ta/tb) in the range of 0.1-0.5.

The conductor layer (b) in this invention is preferably formed from a copper alloy foil. The copper alloy foil here means a foil of an alloy of copper and at least one kind of non-copper element selected from chromium, zirconium, nickel, silicon, zinc, beryllium, and the like with a copper content of 90 wt % or more.

It is preferable to use a copper alloy foil with a copper content of 95 wt % or more. At the same time, the selected foil preferably shows a tensile strength of 500 MPa or more and an electrical conductivity of 65% or more before it is subjected to lamination. When the tensile strength of the conductor layer (b) is less than 500 MPa, the copper foil fails to acquire sufficient strength when the flying lead is formed and a problem such as wire breakage tends to arise. When the electrical conductivity is less than 65%, noise generated from the copper foil resistor is given off as heat and, as a result, the impedance control becomes difficult to exercise and the transmission rate becomes unsatisfactory.

This invention will be described in more detail below with reference to the accompanying examples.

[Determination of Adhesive Strength]

In the test for the adhesive strength between the conductor layer (a) and the insulating layer, linear patterns with a width of 3.2 mm were formed on the stainless steel layer and the conductor layer (a) of a laminate for HDD suspension, a test piece was formed while leaving the conductor layer (b) as it was, pasted to a fixed plate, and mounted on a tensile tester (Strograph-M1, available from Toyo Seiki Co., Ltd.), and the 90° peel strength of the aforementioned linear patterns was measured. On the other hand, in the test for the adhesive strength between the conductor layer (b) and the insulating layer, linear patters with a width of 3.2 mm were formed on the conductor layer (b), a test piece was formed while leaving the stainless steel layer and the conductor layer (a) as they were, and the 90° peel strength between the conductor layer (b) and the insulating layer was determined as above.

[Determination of Linear Expansion Coefficient]

A laminate for HDD suspension was etched to remove the stainless steel layer, the conductor layer (a), and the conductor layer (b), the remaining insulating layer was heated to 250° C. with the aid of a thermomechanical analyzer (available from Seiko Instruments Inc.), maintained at that temperature for 20 minutes, cooled at a rate of 10° C./min, and the mean linear expansion coefficient between 240° C. and 100° C. was calculated.

[Method for Evaluating Occurrence of Crosstalk]

A lead wire with a line width of 25 μm and a distance between lines of 25 μm was formed on the conductor layer (b) by the technique of photo-etching and a flexure for HDD equipped with a magnetic writing apparatus and a magnetic reading apparatus for reading and writing the information on the HDD substrate was formed. Then, a transmitter with an ability to change the frequency freely (frequency response analyzer Model 1260, available from Toyo Corporation; frequency characteristics analyzer FRA5096, available from NF Circuit Design Block Co., Ltd.) was connected to the aforementioned circuit for magnetic writing, AC voltage was applied from one end while changing the frequency from 1 Hz to 15 MHz, the output voltage from the other end was measured, and the ratio of output voltage to applied voltage was calculated. Crosstalk did not occur when attenuation of the applied voltage was not observed and crosstalk occurred when attenuation was observed.

The following abbreviations were used in the synthetic examples.

PMDA: Pyromellitic dianhydride

BTDA: Benzophenone-3,4,3′,4′-tetracarboxylic acid dianhydride

BPDA: 3,3′,4,4′-Biphenyltetracarboxylic acid dianhydride

DANPG: 1,3-Bis(4-aminophenoxy)-2,2-dimethylpropane

MABA: 4-Amino-N-(4-amino-2-methoxyphenyl)benzamide

DAPE: 4,4′-diaminodiphenyl ether

APB: 1,3-Bis(3-aminophenoxy)benzene

BAPP: 2,2′-Bis[4-(4-aminophenoxy)phenyl]propane

m-TB: 2,2′-Dimethyl-4,4′-diaminobiphenyl

DMAc: N,N-Dimethylacetamide

### SYNTHETIC EXAMPLE 1

A solution was prepared by weighing out 10.0 moles of DANPG and dissolving in 35.2 kg of solvent DMAc with stirring in a 40-L planetary mixer. To this solution were added 4.0 moles of PMDA and 6.0 moles of BTDA and the mixture was allowed to undergo polymerization at room temperature for 3 hours with stirring to give a viscous solution of polyimide precursor A.

### SYNTHETIC EXAMPLE 2

A solution was prepared by weighing out 8.0 moles of MABA and 5.0 moles of DAPE and dissolving in 34.3 kg of solvent DMAc with stirring in a 40-L planetary mixer. To this solution was added 13.0 moles of PMDA and the mixture was allowed to undergo polymerization at room temperature for 3 hours with stirring to give a viscous solution of polyimide precursor B.

### SYNTHETIC EXAMPLE 3

A solution was prepared by weighing out 10.0 moles of APB and dissolving in 36.7 kg of solvent DMAc with stirring in a 40-L planetary mixer. To this solution were added 4.0 moles of PMDA and 6.0 moles of BTDA and the mixture was allowed to undergo polymerization at room temperature for 3 hours with stirring to give a viscous solution of polyimide precursor C.

### SYNTHETIC EXAMPLE 4

A solution was prepared by weighing out 7.0 moles of BAPP and dissolving in 25.5 kg of solvent DMAc with stirring in a 40-L planetary mixer. To this solution was added 7.0 moles of BPDA and the mixture was allowed to undergo polymerization at room temperature for 3 hours with stirring to give a viscous solution of polyimide precursor D.

### SYNTHETIC EXAMPLE 5

A solution was prepared by weighing out 7.5 moles of m-TB and dissolving in 25.5 kg of solvent DMAc with stirring in a 40-L planetary mixer. To this solution was added 7.5 moles of BPDA and the mixture was allowed to undergo polymerization at room temperature for 3 hours with stirring to give a viscous solution of polyimide precursor E.

### FABRICATING EXAMPLE 1

A resist was applied to one side of a stainless steel foil (SUS304, tension-annealed and 20 μm-thick, available from Nippon Steel Corporation) and the resist-covered stainless steel foil was passed through a plating bath to give a copper-plated stainless steel foil A which had a layer of copper plating, that is, the conductor layer (a) with a thickness of 0.1 μm and an electrical conductivity of 100% IACS on one side. The surface roughness Ra of the copper plating at this point was 0.05 μm. This surface roughness Ra can be adjusted by changing the voltage and treating time during plating.

### FABRICATING EXAMPLE 2

A resist was applied to one side of a stainless steel foil (SUS304, tension-annealed and 20 μm-thick, available from Nippon Steel Corporation) and the resist-covered stainless steel foil was passed through a plating bath as in Fabricating Example 1 while adjusting the voltage and treating time to give a copper-plated stainless steel foil B which showed a surface roughness Ra of 0.50 μm and had a layer of copper plating, that is, the conductor layer (a) with a thickness of 0.1 μm and an electrical conductivity of 100% IACS on one side.

### EXAMPLE 1

The solution of polyimide precursor A obtained in Synthetic Example 1 was applied to a copper foil (NK-120 with a thickness of 12 μm, a strength of 556 MPa, and an electrical conductivity of 79%, available from Nikko Materials Co., Ltd.) to an after-cure thickness of 1 μm, dried at 110° C. for 3 minutes, the solution of polyimide precursor B obtained in Synthetic Example 2 was applied to the dried layer of the polyimide precursor A to an after-cure thickness of 7.5 μm, dried at 110° C. for 10 minutes, then the solution of polyimide precursor A obtained in Synthetic Example 1 was applied to the dried layer of polyimide precursor B to an after-cure thickness of 1.5 μm, dried at 110° C. for 3 minutes, and the resulting build-up was subjected to a stepwise heat treatment at several temperature levels in the range of 130-360° C., each heat treatment lasting 3 minutes, to complete imidation. The product thus obtained was a laminate having a 10 μm-thick insulating layer of polyimide resin on the copper foil or the conductor layer (b). The first layer of polyimide resin in contact with the copper foil and the third layer of polyimide resin respectively showed a linear expansion coefficient of 58.5×10⁻⁵/° C. as they are constituted of the same polyimide resin while the second layer of polyimide resin showed a linear expansion coefficient of 1.46×10⁻⁵/° C.

The copper-plated stainless steel foil A fabricated in Fabricating Example 1 was placed on the laminate obtained above with the copper plating side or the conductor layer (a) faced to the insulating layer of polyimide and the two were pressed in a vacuum press at 7 MPa and 315° C. for 80 minutes to give a laminate A for HDD suspension. The adhesive strength of the laminate A and the linear expansion coefficient of the polyimide in the laminate A were determined. Moreover, occurrence of crosstalk was evaluated for the laminate A. The results are shown in Table 1.

### EXAMPLE 2

The laminate B for HDD suspension was obtained as in Example 1 with the exception of using the copper-plated stainless steel foil B in place of the copper-plated stainless steel foil A. The adhesive strength of the laminate B and the linear expansion coefficient of the polyimide in the laminate B were determined. Moreover, occurrence of crosstalk was evaluated for the laminate B. The results are shown in Table 1.

### EXAMPLE 3

The solution of polyimide precursor C obtained in Synthetic Example 3 was applied to a copper foil (NK-120 with a thickness of 12 μm, a strength of 556 MPa, and an electrical conductivity of 79%, available from Nikko Materials Co., Ltd.) to an after-cure thickness of 1 μm, dried at 110° C. for 3 minutes, the solution of polyimide precursor B obtained in Synthetic Example 2 was applied to the dried layer of polyimide precursor C to an after-cure thickness of 7.5 μm, dried at 110° C. for 10 minutes, then the solution of polyimide precursor A obtained in Synthetic Example 1 was applied to the dried layer of polyimide precursor B to an after-cure thickness of 1.5 μm, dried at 110° C. for 3 minutes, and the resulting build-up was subjected to a stepwise heat treatment at several temperature levels in the range of 130-360° C., each heat treatment lasting 3 minutes, to complete imidation. The product thus obtained was a laminate having a 10 μm-thick insulating layer of polyimide resin on the copper foil or the conductor layer (b). The linear expansion coefficient was 43.4×10⁻⁵/° C. for the first layer of polyimide resin in contact with the copper foil, 1.46×10⁻⁵/° C. for the second layer of polyimide resin, and 58.5×10⁻⁵/° C. for the third layer of polyimide resin.

The copper-plated stainless steel foil A fabricated in Fabricating Example 1 was placed on the laminate obtained above with the copper plating side or the conductor layer (a) faced to the insulating layer of polyimide and the two were pressed in a vacuum press at 7 MPa and 315° C. for 80 minutes to give a laminate C for HDD suspension. The adhesive strength of the laminate C and the linear expansion coefficient of the polyimide in the laminate C were determined. Moreover, occurrence of crosstalk was evaluated for the laminate C. The results are shown in Table 1.

### EXAMPLE 4

The laminate D for HDD suspension was obtained as in Example 3 with the exception of using the copper-plated stainless steel foil B in place of the copper-plated stainless steel foil A. The adhesive strength of the laminate D and the linear expansion coefficient of the polyimide in the laminate D were determined. Moreover, occurrence of crosstalk was evaluated for the laminate D. The results are shown in Table 1.

### EXAMPLE 5

The solution of polyimide precursor D obtained in Synthetic Example 4 was applied to a copper foil (NK-120 with a thickness of 12 μm, a strength of 556 MPa, and an electrical conductivity of 79%, available from Nikko Materials Co., Ltd.) to an after-cure thickness of 1 μm, dried at 110° C. for 3 minutes, the solution of polyimide precursor E obtained in Synthetic Example 5 was applied to the dried layer of polyimide precursor D to an after-cure thickness of 7.5 μm, dried at 110° C. for 10 minutes, then the solution of polyimide precursor D obtained in Synthetic Example 4 was applied to the dried layer of polyimide precursor E to an after-cure thickness of 1.5 μm, dried at 110° C. for 3 minutes, and the resulting build-up was subjected to a stepwise heat treatment at several temperature levels in the range of 130-360° C., each heat treatment lasting 3 minutes, to complete imidation. The product thus obtained was a laminate having a 10 μm-thick insulating layer of polyimide resin on the copper foil or the conductor layer (b). The first layer of polyimide resin in contact with the copper foil and the third layer of polyimide resin respectively showed a linear expansion coefficient of 59.4×10⁻⁵/° C. as they are constituted of the same polyimide resin while the second layer of polyimide resin showed a linear expansion coefficient of 1.20×10⁻⁵/° C.

The copper-plated stainless steel foil A fabricated in Fabricating Example 1 was placed on the laminate obtained above with the copper plating side or the conductor layer (a) faced to the polyimide side and the two were pressed in a vacuum press at 7 MPa and 315° C. for 80 minutes to give a laminate E for HDD suspension. The adhesive strength of the laminate E and the linear expansion coefficient of the polyimide in the laminate E were determined. Moreover, occurrence of crosstalk was evaluated for the laminate E. The results are shown in Table 1.

### EXAMPLE 6

The laminate F for HDD suspension was obtained as in Example 5 with the exception of using the copper-plated stainless steel foil B in place of the copper-plated stainless steel foil A. The adhesive strength of the laminate F and the linear expansion coefficient of the polyimide in the laminate F were determined. Moreover, occurrence of crosstalk was evaluated for the laminate F. The results are shown in Table 1.

### EXAMPLE 7

The solution of polyimide precursor A obtained in Synthetic Example 1 was applied to the copper side of the copper-plated stainless steel foil A fabricated in Fabricating Example 1 to an after-cure thickness of 1 μm, dried at 110° C. for 3 minutes, the solution of polyimide precursor B obtained in Synthetic Example 2 was applied to the dried layer of polyimide precursor A to an after-cure thickness of 7.5 μm, dried at 110° C. for 10 minutes, then the solution of polyimide precursor A obtained in Synthetic Example 1 was applied to the dried layer of polyimide precursor B to an after-cure thickness of 1.5 μm, dried at 110° C. for 3 minutes, and the resulting build-up was subjected to a stepwise heat treatment at several temperature levels in the range of 130-360° C., each heat treatment lasting 3 minutes, to complete imidation. The product thus obtained was the copper-plated stainless steel foil A which had an insulating multilayer of polyimide resins with a total thickness of 10 on the copper plating or the conductor layer (a). The first layer of polyimide resin in contact with the copper plating and the third layer of polyimide resin respectively showed a linear expansion coefficient of 58.5×10⁻⁵/° C. as they are constituted of the same polyimide resin while the second layer of polyimide resin showed a linear expansion coefficient of 1.46×10⁻⁵/° C.

A copper foil (NK-120 with a thickness of 12 μm, a strength of 556 MPa, and an electrical conductivity of 79%, available from Nikko Materials Co., Ltd.) as the conductive layer (b) was placed on the laminate obtained above with the copper side faced to the polyimide side and the two were pressed in a vacuum press at 7 MPa and 315° C. for 80 minutes to give a laminate G for HDD suspension. The adhesive strength of the laminate G and the linear expansion coefficient of the polyimide in the laminate G were determined. Moreover, occurrence of crosstalk was evaluated for the laminate G. The results are shown in Table 2.

### EXAMPLE 8

The laminate H for HDD suspension was obtained as in Example 7 with the exception of using the copper-plated stainless steel foil B in place of the copper-plated stainless steel foil A. The adhesive strength of the laminate H and the linear expansion coefficient of the polyimide in the laminate H were determined. Moreover, occurrence of crosstalk was evaluated for the laminate H. The results are shown in Table 2.

### EXAMPLE 9

The solution of polyimide precursor A obtained in Synthetic Example 1 was applied to the copper side of the copper-plated stainless steel foil A fabricated in Fabricating Example 1 to an after-cure thickness of 1 μm, dried at 110° C. for 3 minutes, the solution of polyimide precursor B obtained in Synthetic Example 2 was applied to the dried layer of polyimide precursor A to an after-cure thickness of 7.5 μm, dried at 110° C. for 10 minutes, then the solution of polyimide precursor C obtained in Synthetic Example 3 was applied to the dried layer of polyimide precursor B to an after-cure thickness of 1.5 μm, dried at 110° C. for 3 minutes, and the resulting build-up was subjected to a stepwise heat treatment at several temperature levels in the range of 130-360° C., each heat treatment lasting 3 minutes, to complete imidation. The product thus obtained was the copper-plated stainless steel foil A which had an insulating multilayer of polyimide resins with a total thickness of. 10 μm on the copper plating or the conductor layer (a). The linear expansion coefficient was 58.5×10⁻⁵/ ° C. for the first layer of polyimide resin in contact with the copper plating, 1.46×10⁻⁵/° C. for the second layer of polyimide resin, and 43.4×10⁻⁵/° C. for the third layer of polyimide resin.

A copper foil (NK-120 with a thickness of 12 μm, a strength of 556 MPa, and an electrical conductivity of 79%, available from Nikko Materials Co., Ltd.) as the conductor layer (b) was placed on the laminate obtained above with the copper side faced to the polyimide side and the two were pressed in a vacuum press at 7 MPa and 315° C. for 80 minutes to give a laminate I for HDD suspension. The adhesive strength of the laminate I and the linear expansion coefficient of the polyimide in the laminate I were determined. Moreover, occurrence of crosstalk was evaluated for the laminate I. The results are shown in Table 2.

### EXAMPLE 10

The laminate J for HDD suspension was obtained as in Example 9 with the exception of using the copper-plated stainless steel foil B in place of the copper-plated stainless steel foil A. The adhesive strength of the laminate J and the linear expansion coefficient of the polyimide in the laminate J were determined. Moreover, occurrence of crosstalk was evaluated for the laminate J. The results are shown in Table 2.

### EXAMPLE 11

The solution of polyimide precursor D obtained in Synthetic Example 4 was applied to the copper side of the copper-plated stainless steel foil A fabricated in Fabricating Example 1 to an after-cure thickness of 1 μm, dried at 110° C. for 3 minutes, the solution of polyimide precursor E obtained in Synthetic Example 5 was applied to the dried layer of polyimide precursor D to an after-cure thickness of 7.5 μm, dried at 110° C. for 10 minutes, then the solution of polyimide precursor D obtained in Synthetic Example 4 was applied to the dried layer of polyimide precursor E to an after-cure thickness of 1.5 μm, dried at 110° C. for 3 minutes, and the resulting build-up was subjected to a stepwise heat treatment at several temperature levels in the range of 130-360° C., each heat treatment lasting 3 minutes, to complete imidation. The product thus obtained was the copper-plated stainless steel foil A which had an insulating multilayer of polyimide resins with a total thickness of 10 μm on the copper plating or the conductor layer (a). The first layer of polyimide resin in contact with the copper plating and the third layer of polyimide resin respectively showed a linear expansion coefficient of 59.4×10⁻⁵/° C. as they are constituted of the same polyimide resin while the second layer of polyimide resin showed a linear expansion coefficient of 1.20×10⁻⁵/° C.

A copper foil (NK-120 with a thickness of 12 μm, a strength of 556 MPa, and an electrical conductivity of 79%, available from Nikko Materials Co., Ltd.) as the conductor layer (b) was placed on the laminate obtained above with the copper side faced to the polyimide side and the two were pressed in a vacuum press at 7 MPa and 315° C. for 80 minutes to give a laminate K for HDD suspension. The adhesive strength of the laminate K and the linear expansion coefficient of the polyimide in the laminate K were determined. Moreover, occurrence of crosstalk was evaluated for the laminate K. The results are shown in Table 2.

### EXAMPLE 12

The laminate L for HDD suspension was obtained as in Example 11 with the exception of using the copper-plated stainless steel foil B in place of the copper-plated stainless steel foil A. The adhesive strength of the laminate L and the linear expansion coefficient of the polyimide in the laminate L were determined. Moreover, occurrence of crosstalk was evaluated for the laminate L. The results are shown in Table 2.

### COMPARATIVE EXAMPLES 1-6

The laminates M to R for HDD suspension were obtained respectively from a stainless steel foil (SUS304, tension-annealed and 20 μm-thick, available from Nippon Steel Corporation) as in Examples 1, 3, 5, 7, 9, and 11 with the exception of not performing copper plating. They were tested and evaluated for the adhesive strength, linear expansion coefficient, and occurrence of crosstalk as in Examples 1-12 and the results are shown in Table 3.

TABLE 1

| | | Example 1 | Example 2 | Example 3 | Example 4 | Example 5 | Example 6 |
|---|---|---|---|---|---|---|---|
| | | Laminate A | Laminate B | Laminate C | Laminate D | Laminate E | Laminate F |
| Adhesive | Resin-copper | 0.06 | 1.29 | 0.02 | 1.23 | 0.05 | 1.36 |
| strength | plating | | | | | | |
| (kN/m) | Resin-copper | 1.15 | 1.14 | 1.18 | 1.15 | 1.21 | 1.22 |

| | | | | | | |
|---|---|---|---|---|---|---|
| Linear expansion | 2.1 | 2.1 | 2.2 | 2.3 | 2.4 | 2.3 |
| coefficient (×10⁻⁵/° C.) | | | | | | |
| Crosstalk | Absent | Absent | Absent | Absent | Absent | Absent |

* In the column for the adhesive strength, “resin-copper plating” denotes the adhesive strength between the insulating layer and the conductor layer (a) while “resin-copper” denotes the adhesive strength between the insulating layer and the conductor layer (b) (this also holds for Tables 2 and 3).

TABLE 2

| | | Example 7 | Example 8 | Example 9 | Example 10 | Example 11 | Example 12 |
|---|---|---|---|---|---|---|---|
| | | Laminate G | Laminate H | Laminate I | Laminate J | Laminate K | Laminate L |
| Adhesive | Resin-copper | 0.16 | 1.34 | 0.19 | 1.41 | 0.23 | 1.53 |
| strength | plating | | | | | | |
| (kN/m) | Resin-copper | 1.08 | 1.11 | 1.11 | 1.09 | 1.19 | 1.15 |

| | | | | | | |
|---|---|---|---|---|---|---|
| Linear expansion | 2.2 | 2.3 | 2.3 | 2.1 | 2.3 | 2.3 |
| coefficient (×10⁻⁵/° C.) | | | | | | |
| Crosstalk | Absent | Absent | Absent | Absent | Absent | Absent |

TABLE 3

| | | Comparative | Comparative | Comparative | Comparative | Comparative | Comparative |
|---|---|---|---|---|---|---|---|
| | | Examples 1 | Examples 2 | Examples 3 | Examples 4 | Examples 5 | Examples 6 |
| | | Laminate M | Laminate N | Laminate O | Laminate P | Laminate Q | Laminate R |
| Adhesive | Resin-stainless | 0.14 | 1.09 | 0.09 | 1.11 | 0.12 | 1.24 |
| strength | steel | | | | | | |
| (kN/m) | Resin-copper | 1.15 | 1.18 | 1.21 | 1.08 | 1.11 | 1.19 |

| | | | | | | |
|---|---|---|---|---|---|---|
| Linear expansion | 2.1 | 2.2 | 2.4 | 2.2 | 2.3 | 2.3 |
| coefficient (×10⁻⁵/° C.) | | | | | | |
| Crosstalk | Present | Present | Present | Present | Present | Present |

What is claimed is:

1. A laminate for HDD suspension comprising a stainless steel layer, a conductor layer (a), an insulating layer, and a conductor layer (b) wherein the conductor layer (a) consists of a layer of metal showing an electrical conductivity in the range of 10-100% IACS, the stainless steel layer is 10-50 μm in thickness, the conductor layer (a) is 0.1-10 μm in thickness, the insulating layer is 5-20 μm in thickness, the conductor layer (b) is 5-50 μm in thickness, and the insulating layer consists of a polyimide resin showing a linear expansion coefficient of 1×10⁻⁵-3×10⁻⁵/° C.

2. A laminate for HDD suspension as described in claim 1 wherein the adhesive strength between the insulating layer and the conductor layer (a) is in the range of 0.5-10.0 kN/m and the adhesive strength between the insulating layer and the conductor layer (b) is in the range of 0.5-10.0 kN/m.

3. A laminate for HDD suspension as described in claim 1 wherein the surface roughness Ra of the surface of the conductor layer (a) on the side of the insulating layer is 0.1-1.0 μm.

4. A method for manufacturing a laminate for HDD suspension which comprises applying a solution of a polyimide precursor or polyimide resin in one layer or more to a conductor layer (a) of a laminate consisting of a stainless steel layer with a thickness of 10-50 μm and a conductor layer (a) with a thickness of 0.1-10 μm, drying and heating at 250° C. or above thereby forming an insulating layer of a polyimide resin showing a linear expansion coefficient of 1×10⁻⁵-3×10⁻⁵/° C. in a thickness of 5-20 μm, placing a conductor layer (b) with a thickness of 5-50 μm on the insulating layer, and pressing under heat and pressure.

5. A method for manufacturing a laminate for HDD suspension which comprises applying a solution of a polyimide precursor or polyimide resin in one layer or more to a conductor layer (b) with a thickness of 5-50 μm, drying and heating at 250° C. or above thereby forming an insulating layer of a polyimide resin showing a linear expansion coefficient of 1×10⁻⁵-3×10⁻⁵/° C. in a thickness of 5-20 μm, placing a laminate consisting of a stainless steel layer with a thickness of 10-50 μm and a conductor layer (a) with a thickness of 0.1-10 μm with the conductor layer (a) faced to the aforementioned insulating layer, and pressing under heat and pressure.
